(19) United States
(12) Patent Application Publication
(10) Pub. No.: US 2014/0188746 A1
(43) Pub. Date: Jul. 3, 2014

(54) SYSTEMS, METHODS, AND DEVICES FOR DETERMINING ALIGNMENT OF EDUCATION CONTENT TO ONE OR MORE EDUCATION STANDARDS

(71) Applicant: Jiaojiao Li, New York, NY (US)

(72) Inventor: Jiaojiao Li, New York, NY (US)

(21) Appl. No.: 14/145,924

(22) Filed: Dec. 31, 2013

Related U.S. Application Data
(60) Provisional application No. 61/747,372, filed on Dec. 31, 2012.

(51) Int. Cl. G06Q 50/20; G06Q 10/10

(52) U.S. Cl. CPC G06Q 50/205; G06Q 10/10
USPC 705/326

(57) ABSTRACT

Systems, methods, and devices are disclosed for aligning Education Content to Education Standards and determining the degree of such alignment for educators and adaptive learning systems to effectively determine and deliver the most aligned Education Content to address each student's specific learning needs according to the set of Education Standards.

### CROSS-REFERENCE TO RELATED APPLICATIONS

The present application is related to and claims benefit under 35 U.S.C. §119(e) from U.S. Provisional Patent Application Ser. No. 61/747,372 filed Dec. 31, 2012, titled “Method and Apparatus for Identifying Alignment of Educational Content to Educational Standards and Calculating the Percentage of Alignment”, the entire contents of which is being incorporated herein by reference.

### BACKGROUND OF THE INVENTION

By any education policy, educators must teach students according to at least one set of Education Standards. Education Standards are subject-specific, grade-specific academic requirements and learning objectives set by the education authorities such as state, provincial, federal, and/or national governments, and district and/or school administrators. In some instances, an educator may have the need to teach students according to more than one set of Education Standards. For example, an educator may need to teach students according to a state's Education Standards (e.g. Massachusetts State) and a federal set of Education Standards (e.g. the Common Core State Standards). However, there have been no systematic, objective tools nor methodologies for Education Content publishers, providers, and distributors (collectively called Education Content providers) to accurately align Education Content to Education Standards to publish, provide, and distribution such content for educators to use to teach such standards. Nor can educators easily, objectively, and accurately determine to what extent a piece of Education Content aligns to one or more sets of Education Standards and thus determine the most suited pieces of Education Content to teach with or for students to learn any particular Education Standards.

Therefore, there is a need for systems, methods, and devices to standardize the process of aligning Education Content to Education Standards, and to determine the degree of such alignment for educators and adaptive learning systems to effectively decide and deliver the best and most aligned Education Content to address each student's specific learning needs for them to meet the learning objectives according to the set of Education Standards they are required to learn.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A is a block diagram of a system for determining alignment of Education Content to one or more Education Standards and the degree of such alignment, in accordance with some embodiments.

FIG. 1B is a block diagram of a system for determining alignment of Education Content to one or more Education Standards and the degree of such alignment, in accordance with some embodiments.

FIG. 1C is a flow chart of a method for aligning Education Content to one or more Education Standards and determining the degree of such alignment, in accordance with some embodiments.

FIG. 2 is a block diagram of Repository of Education Standards used in a system for storing one or more sets of Education Standards and determining the alignment of Education Content to one or more Education Standards, in accordance with some embodiments. Each set of Education Standards contains one or more Education Standards.

FIG. 3 is a block diagram of Repository of Educational Components used in a system for storing Educational Components and determining the alignment of Education Content to one or more Education Standards, in accordance with some embodiments.

FIG. 4 is a chart illustrating an example of weight assignment scenarios for Educational Components comprising and Education Standard Identifier, in accordance with some embodiments.

FIG. 5A is an embodiment of a method of generating an Education Standard Identifier, in accordance with some embodiments.

FIG. 5B is a chart illustrating an example structure of an Education Standard Identifier, in accordance with some embodiments.

FIG. 5C is a block diagram showing Education Standard Identifiers correlated to Education Standards, in accordance with some embodiments.

FIG. 6A is an embodiment of a method of generating an Education Content Identifier, in accordance with some embodiments.

FIG. 6B is chart illustrating an example structure of an Education Content Identifier, in accordance with some embodiments.

FIG. 6C is a block diagram describing the Educational Components' correlation to Education Standard Identifiers and to Education Content Identifier, in accordance with some embodiments.

FIGS. 7A-7B are flowcharts of methods of aligning Education Content to Education Standards and determining the degree of such alignment, in accordance with some embodiments.

FIG. 7C is a chart comparing an Education Content Identifier to an Education Standard Identifier, in accordance with some embodiments.

FIG. 8 is a diagram to determine the adjustment to the Education Content's alignment to Education Standards based on the hierarchical focus of the Education Content on various Educational Components selected to represent such Education Content in comparison to those representing each Education Standard to accurately determine the degree of such alignment in accordance with some embodiments.

FIG. 9 is a block diagram of Repository of Education Content used in a system for storing Education Content and determining the alignment of Education Content to one or more Education Standards, in accordance with some embodiments.

FIG. 10 is a flowchart of a method of calculating a piece of Education Content's average alignment score to one or more Education Standards, in accordance to some embodiments.

FIG. 11 is a chart of an example of the display of a piece of Education Content's public average alignment score to Education Standards, in accordance with some embodiments.

FIG. 12 is a block diagram describing the correlation among user data, Education Content Identifier, and Education Content, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Systems, methods, and devices for determining alignment of Education Content to one or more Education Standards are disclosed. Such systems, methods, and devices include storing one or more sets of one or more Education Standards in a Repository of Education Standards as well as storing one or more Educational Components. The Educational Components are shorter phrases describing the key learning concepts, skills, and/or other requirements and objectives elaborated in greater detail in each Education Standard for students to attain. The Educational Components are grouped under parallel and/or hierarchical categories such as “Concepts” and “Skills” categories, etc., and are stored in the Repository of Educational Components. Further, the systems, methods, and devices include generating and correlating one or more Educational Components to save in the Repository of Educational Components to compose an Education Standard Identifier to represent each Education Standard. In addition, the systems, methods, and devices include determining a ranking for each Educational Component in representing an Education Standard wherein such ranking in representing an Education Standard has a ranking basis. Moreover, the systems, methods, and devices include assigning a weight to the ranking of each Educational Component in representing an Education Standard. Also, the systems, methods, and devices include generating an Education Standard Identifier for each Education Standard based on the one or more Educational Components generated for the Education Standard, the ranking assigned to each of these Educational Components, and the weight assigned to each of these Educational Components at their each respective ranking. Further, the systems, methods, and devices include storing the Education Standard Identifiers in a Repository of Education Standard Identifiers. The systems, methods, and devices include storing one or more pieces of Education Content in a Repository of Education Content. In addition, the systems, methods, and devices include identifying one or more Educational Components from the Repository of Educational Components to generate an Education Content Identifier to represent each piece of Education Content. Moreover, the systems, methods, and devices include determining a ranking for each Educational Component in representing the prioritized educational focuses addressed by the piece of Education Content wherein such ranking in representing the Education Content has the same ranking basis as the ranking basis in composing an Education Standard Identifier to represent an Education Standard. Also, the systems, methods, and devices include generating one or more Education Content Identifiers for each piece of Education Content based on the identified one or more Educational Components and the ranking of these each identified one or more Educational Components. The systems, methods, and devices include storing the Education Content Identifiers in a Repository of Education Content Identifiers. Further, the systems, methods, and devices include comparing an Education Content Identifier to the Education Standard Identifiers to determine if it has one or more Educational Components in common with those in each of the Education Standard Identifiers and if a match is identified, the Education Content correlated to this Education Content Identifier is determined as aligned to such Education Standard Identifier and therefore aligned to the Education Standard correlated to such Education Standard Identifiers. In addition, the systems, methods, and devices include calculating the Education Content's degree of alignment to each of the Education Standard by processing the number of common Educational Components in the Education Content Identifier matched to the Education Standard Identifier for each of the Education Standards, the ranking of each Educational Component in the Education Content Identifier relative to that in each of the matched Education Standard Identifiers, the weights the relative rankings capture based on the assigned weights of the common Educational Components in each Education Standard Identifier, and the Weight Discounting Factors corresponding to the relativity of the rankings to apply to the weights captured.

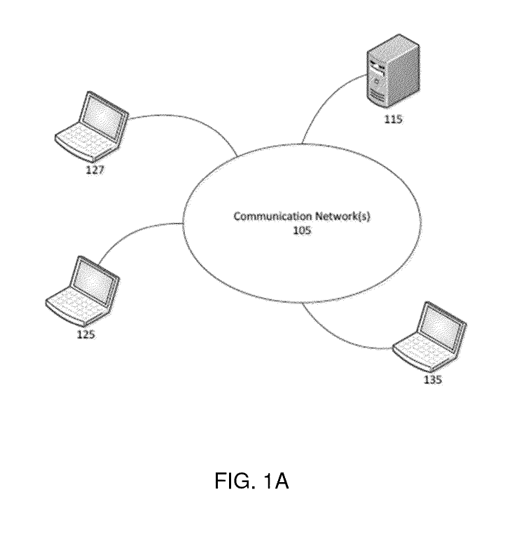

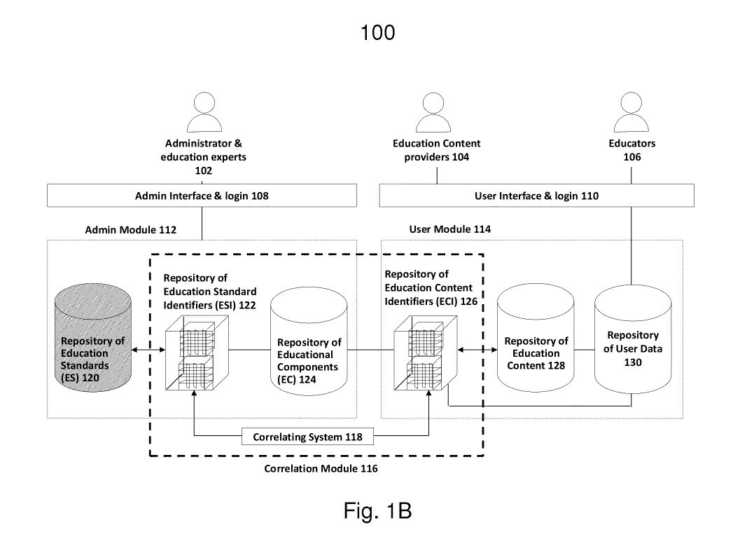

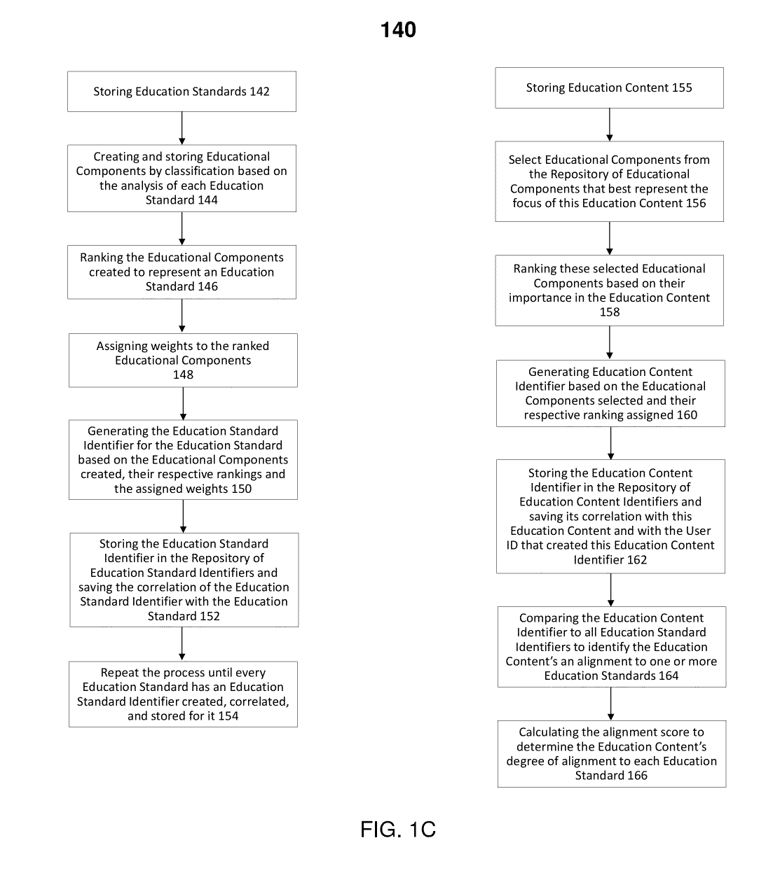

FIG. 1A is a block diagram of a system 101 for determining alignment of Education Content to one or more Education Standards and the degree of such alignment in accordance with some embodiments. Such a system may be implemented by a computer server 115 or a group of computer servers co-located or locating in geographical separate locations. Such a system 101 may include computer server 115 hosting a website accessible by administrators of the system, education experts, education standard providers, education content providers, educators, or any other users. Access to the system may be via a web browser (or any other compatible user interface) on a user computing device (e.g. desktop computer, laptop computer, tablet computer, smartphone or any other computing device). Further, a user may provide instructions to the computer server 115 to perform certain functions described herein.

The system includes one or more communication networks 105 (e.g. landline communication networks, wireless communication networks, Internet, cellular communication networks, WiFi, public switched telephone network (PSTN), etc.). Further, the system includes an Education Standard provider device 125 coupled to the one or more communication networks 105. An Education Standard provider may be a system administrator or education experts described herein. The Education Standard provider device 125 can be a desktop computer, laptop computer, tablet computer, smartphone or any other computing device. In addition, a computer server 115 is coupled to the one or more communication networks 105. The Education Standard provider device 125 transmits one or more Education Standards over the one or more communication networks 105 to the computer server 115 or may cause the computer server 115 to receive the Education Standards from some other repository (e.g. administrator database, third-party database, cloud database, etc.). Moreover, the computer server 115 receives the one or more Education Standards from the Education Standard provider device 125 over the one or more communication networks 105 and stores one or more Education Standards in a Repository of Education Standards coupled to the computer server 115. —An example Education Standard in mathematics for grade 2 may be “Determine whether a group of objects (up to 20) has an odd or even number of members, e.g., by pairing objects or counting them by 2s; write an equation to express an even number as a sum of two equal addends.” In addition, an administrator may use an administrator device 127 (e.g. desktop computer, laptop computer, tablet computer, smartphone or any other computing device) may transmit and store one or more Educational Components in a repository of Educational Components coupled to computer server 115. The administrator may determine the Educational Components by analyzing an Education Standard and decomposing such Education Standard into Educational Components described herein. Such Educational Components may be transmitted from the administrator device 127 to the repository of Educational Components over communication network 105 or may cause the computer server 115 to receive the Educational Components from some other repository (e.g. administrator database, third-party database, cloud database, etc.). An Educational Component may be phrases defining learning concepts, skills, demonstrations and/or other requirements and objectives set by each Education Standard for students to attain and can be grouped under parallel or hierarchical categories such as “Concepts” and “Skills” type categories, etc.

Further, the computer server 115, upon input from the Education Standard provider, administrator, or education expert (through a computing device (125, 127), determines or identifies one or more Educational Components from the Repository of Educational Components to generate an Education Standard Identifier to represent each Education Standard (stored in the Repository of Education Standards). For the example Education Standard in mathematics for grade 2, —“Determine whether a group of objects (up to 20) has an odd or even number of members, e.g., by pairing objects or counting them by 2s; write an equation to express an even number as the sum of two equal addends” may include three Educational Components of the “concept” type—“the concept of whole number multiplication and division”, “numbers parity: odd and even numbers”, and “whole number counting” and three Educational Components of the “skill” type—“working with equal groups of objects to gain foundations for multiplication”, “skip-counting by 2s, or 5s, 10s, 100s etc.”, “differentiating odd vs even numbers”.

In addition, the computer server 115, upon input from the Education Standard provider, administrator, or education expert (through a computing device (125, 127), determines a ranking for each Educational Component in representing an Education Standard. Each such ranking having a ranking basis. Moreover, the computer server 115, upon input from the Education Standard provider, administrator, or education expert (through a computing device (125, 127), assigns a percentage numerical weight to the ranking of each Educational Component in representing an Education Standard. Further, the computer server 115 generates an Education Standard Identifier for each Education Standard stored in the Repository of Education Standards based on the identified Educational Components, ranking of each of the identified Educational Components, and the assigned weight to each Educational Component at such ranking. Further details of determining ranking of Educational Components, assigning weights at each ranking and generating an Education Standard Identifier are provided herein.

In addition, the computer server 115 receives one or more pieces of Education Content over the one or more communication networks 105 and stores one or more pieces of Education Content in a Repository of Education Content coupled to the computer server 115. In addition, an Education Content provider (e.g. user) may use an Education Content provider device 135 (e.g. desktop computer, laptop computer, tablet computer, smartphone or any other computing device) to transmit and store one or more pieces of Education Content in the Repository of Education Content coupled to computer server 115. Such Education Content may be transmitted from the Education Content provider device 135 to the Repository of Education Content over communication network 105 or may cause the computer server 115 to receive the pieces of Education Content from some other repository (e.g. Education Content provider database, third-party database, cloud database, etc.). Education Content can be learning materials, programs, resources, and activities, etc. Such Education Content can be in of different types such as lessons, homework, quizzes, practice exercises, or other materials. Also, Education Content may be in different formats such as text, video, game, application, or other formats.

Further, the computer server 115 determines or identifies one or more Educational Components from the Repository of Educational Components to generate one or more Education Content Identifiers to represent each piece of Education Content (stored in the Repository of Education Content). In addition, the computer server 115, upon Education Content provider's (e.g. user) input, determines a ranking for each Educational Component in representing a piece of Education Content. Such ranking in the representing of the piece of Education Content has the same ranking basis as the ranking basis in representing an Education Standard. Also, the computer server 115 generates an Education Content Identifier for each piece of Education Content based on the identified one or more Educational Components and the ranking of each identified Educational Components. The computer server 115 may repeat the process to generate more than one Education Content Identifiers when there are multiple times of input from one or more users' input. Moreover, the computer server 115 stores the generated Education Content Identifiers in a Repository of Education Content Identifiers.

In a further embodiment, upon user input, the computer server 115 may compare an Education Content Identifier to the Education Standard Identifiers to determine if it has one or more Educational Components are in common with those in each of the Education Standard Identifiers and when a match is identified, the Education Content correlated to this Education Content Identifier is determined as aligned to such Education Standard Identifier and therefore aligned to the Education Standard correlated to such Education Standard Identifiers. In addition, the computer server 115 calculates the Education Content's degree of such alignment to each of the Education Standards by processing the number of common Educational Components in the Education Content Identifier matched to the Education Standard Identifier for each of the Education Standards, the ranking of each Educational Component in the Education Content Identifier relative to that in each of the matched Education Standard Identifiers, the weights the relative rankings capture based on the assigned weights of the common Educational Components in each Education Standard Identifiers, and the Weight Discounting Factors corresponding to the relativity of the rankings to apply to the weights captured. Further details in comparing an Education Content Identifier to an Education Standard Identifier to identify an alignment and calculating the degree of such alignment of the Education Content Identifier's correlated Education Content to the Education Standard Identifier's correlated Education Standard is described herein.

FIG. 1B is a block diagram of a system 100 for determining alignment of Education Content to one or more Education Standards and the degree of such alignment in accordance with some embodiments. The system 100 may be implemented by one or more computer servers. Further, the system 100 may include an administration (Admin) Module 112, which is accessible through an admin interface 108 by one or more administrators of the system and/or authorized education experts 102. The Admin Module 112 includes a Repository of Education Standards (ES) 120, a Repository of Educational Components (EC) 124, and a Repository of Education Standard Identifiers (ESI) 122. The administrator and/or authorized education experts 102 may cause the computer server implementing system 100 to store Education Standards in the Repository of Education Standards 120. The Repository of Education Standards 120 may include one or more sets of one or more Education Standards. For example, the Repository of Education Standards 120 may include Education Standards for one or more US states (e.g. Massachusetts, Texas, etc.) and federal Education Standards (e.g. Common Core) for one or more subjects such as English Language Arts, Math, Sciences, etc., as well as international Education Standard (e.g. China's math standards, UK's science standards, etc.).

Each Education Standard in the Repository of Education Standards 120 may include one or more Educational Components. The administrator and/or education experts 102 may generate, upload, and/or store Educational Components in the Repository of Educational Components 124 by decomposing one or more Education Standards as described herein. Further, the system 100 may generate an Education Standard Identifier for one or more Education Standards stored in the Repository of Education Standards 120. Such Education Standard Identifier correlates to the Education Standard it represents and is composed of the Educational Components (that are stored in the Repository of Educational Components 124). Further, details for generating Education Standard Identifiers are described herein. Educational Components stored in the Repository of Educational Components 124 may include Education Components of various types such as concepts, skills as well as other types of Education Components such as demonstrations by drawing, etc. as required by an Education Standard.

Further, the system 100 includes a User Module 114, which is accessible through a user interface 110 by Education Content publishers, Education Content providers, and/or Education Content distributors (collectively called Education Content providers) 104 and educators 106. Further, the User Module 114 includes a Repository of User Data 130 of user information (e.g. user identification information user contact information, user login information, etc.), a Repository of Education Content 128 of user uploaded Education Content, Education Content information, and Education Content access directories, etc., and a Repository of Education Content Identifiers 126. Further, the system 100 may generate one or more Education Content Identifiers for one or more pieces of Education Content stored in the Repository of Education Content 128. Such Education Content Identifier correlates to the Education Content it represents and is composed of the Educational Components (that are stored in the Repository of Educational Components 124). Further, details for generating Education Content Identifiers are described herein.

The Education Standard Identifiers and the Education Content Identifiers include combinations of Educational Components created by the system administrators and by users respectively through selecting and ranking Educational Components from the Repository of Educational Components 124. A Correlation Module 116 includes the Repository of Educational Components 124, Repository of Education Standard Identifiers 122, Repository of Education Content Identifiers 126, and the Correlating System 118 that correlates (or align) the Education Content to Education Standards using the Education Content Identifiers stored in the Repository of Education Content Identifiers 126 and the Education Standard Identifiers stored in the Education Standards Identifier Repository 122. Further, as shown in FIG. 1B, the Educational Components are the central linkage between Education Content Identifiers and Education Standard Identifiers, the latter two of which further link the Education Standards and Education Content to the Educational Components respectively. Such linkage thus further links Education Content to Education Standards to identify an alignment of the former to the latter. The correlation system 118 determines the degree of alignment of a piece of Education Content to an Education Standard by comparing the respective Education Content Identifier to the respective Education Standard Identifier as described herein.

Unlike correlation tools in the current state of the art, embodiments of the present disclosure make content-standard alignment a continuous variable, with values ranging from 0% to 100%. Through a guided alignment process for system administrators and users, the system 100 can pinpoint in each specific Education Standard to an Educational Component and pinpoint a degree of importance to the objectives of this standard is addressed or not addressed by a piece of Education Content. The differentiated alignment allows educators to more easily determine a piece of Education Content's conceptual focus and difficulty level, to understand at a glance a piece of Education Content's relevancy to an Education Standard educators need to teach to, and therefore saves the educators significant amount of time and effort from discovering, differentiating, and evaluating content and materials as compared to current state of the art. The calculated alignment score and differentiation of embodiments of the present disclosure thus further enable educators to focus on the quality and result-oriented impact of Education Content materials provided to individual students, which the current state of the content correlation tools fail to address or address well. Embodiments of the present disclosure can serve as an educational framework of any Education Content recommendation engine or content curation tool to help educators deliver personalized learning.

FIG. 1C is a flow chart of a method 140 for aligning Education Content to one or more Education Standards and determining the degree of such alignment in accordance with some embodiments. The method 140 includes storing one or more sets of one or more Education Standards in a Repository of Education Standards, as shown in block 142. The method 140 further includes creating and storing one or more Educational Components by classification in a Repository of Educational Components based on the analysis of each Education Standard, as shown in block 144. In addition, the method 140 includes ranking the Educational Components created to represent an Education Standard, as shown in block 146. Moreover, method 140 includes assigning weights to the ranked Educational Components, as shown in block 148. The method 140 also includes generating the Education Standard Identifier for the Education Standard based on the Educational Components created for such Education Standard, their respective rankings and assigned weights, as shown in block 150. The method 140 further includes storing the Education Standard Identifier in the Repository of Education Standard Identifiers and saving the correlation of the Education Standard Identifier with the Education Standard 152. The method 140 further includes repeating the process until every Education Standard has an Education Standard Identifier created, correlated, and stored for it as shown in bock 154.

The method 140 includes storing Education Content, as shown in block 155. Further, method 140 includes selecting Educational Components from the Repository of Educational Components that best represent the focus of the Education Content, as shown in block 156. In addition, the method 140 includes ranking these selected Educational Components based on their importance in the Education Content, as shown in block 158. Moreover, the method 140 includes generating an Education Content Identifier based on the Educational Components selected and their respective ranking assigned, as shown in block 160. The method 140 also includes storing the Education Content Identifier in the Repository of Education Content Identifiers and saving its correlation with the Education Content and its correlation with the User ID (or other user data such as user login information) that created this Education Content Identifier, as shown in block 162. The method 140 further includes comparing the Education Content Identifier to all Education Standard Identifiers to identify the Education Content's alignment to one or more Education Standards, as shown in block 164. In addition, the method 140 includes calculating the alignment score to determine the Education Content's degree of alignment to each Education Standard, as shown in block 166. In one embodiment, the steps of method 140 may be implemented by the system shown in FIG. 1B including the admin module, user module, correlation module, and correlating system.

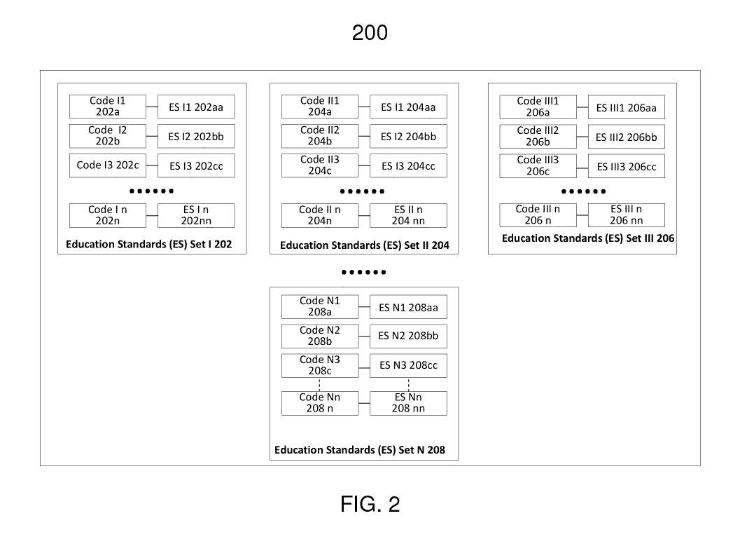

FIG. 2 is a block diagram of Repository of Education Standards used in a system for storing one or more sets of Education Standards and determining alignment of Education Content to one or more Education Standards in accordance with some embodiments. Each set of Education Standards contains one or more Education Standards. In such an embodiment, the Repository of Education Standards 200 includes (but is not limited to) Education Standards set I 202, Education Standards set II 204, Education Standards set III 206, as well as many Education Standards set N the administrators or authorized education exports store in the Repository of Education Standards (where N is any number of Education Standards Sets). Each set of standards (202, 204, 206, 208) may include Education Standards for one or more US states (e.g. Massachusetts, Texas, etc.) and federal Education Standards (e.g. Common Core) for one or more subjects such as English Language Arts, Math, Sciences, etc., as well as foreign international Education Standard (e.g. China's math standards, UK's science standards, etc.). Note, although FIG. 2 shows four sets of Education Standards (202, 204, 206, 208), more sets of Education Standards may be stored in the Repository of Education Standards 200.

Each Education Standards set (202-208) may have any number of education standards (202a-202n, 204a-204n, 206a-206n, 208a-208n). Further, each Education Standard set (202-208) includes a code (202a-n, 204a-n, 206a-n, 208a-n) mapped or associated to an Education Standard (202aa-nn, 204aa-nn, 206aa-nn, 208aa-nn) within each Education Standard set (202, 204, 206, 208). A code may be an alphanumeric character string that allows an administrator, as well as modules (e.g. software and hardware) implemented by a computer server, another way in which to identify an Education Standard other than the detailed description of the Education Standard. For example, the Education Standard, “Interpret products of whole numbers,” can be associated with a code, “3.OA.1”

Referring to FIG. 1B, authorized education experts and/or system administrators can access an Admin Module 112 through the admin interface 108 to input and store one set or multiple sets of Education Standards (202-208) in the Repository of Education Standards on a computer server. The system administrators can input the Education Standards' codes in addition to the Education Standards' descriptions to differentiate Education Standard sets. The Education Standards can be stored as any single set or multiple sets grouped by subject matters, by grade levels, or by sponsoring authorities, countries, or regions.

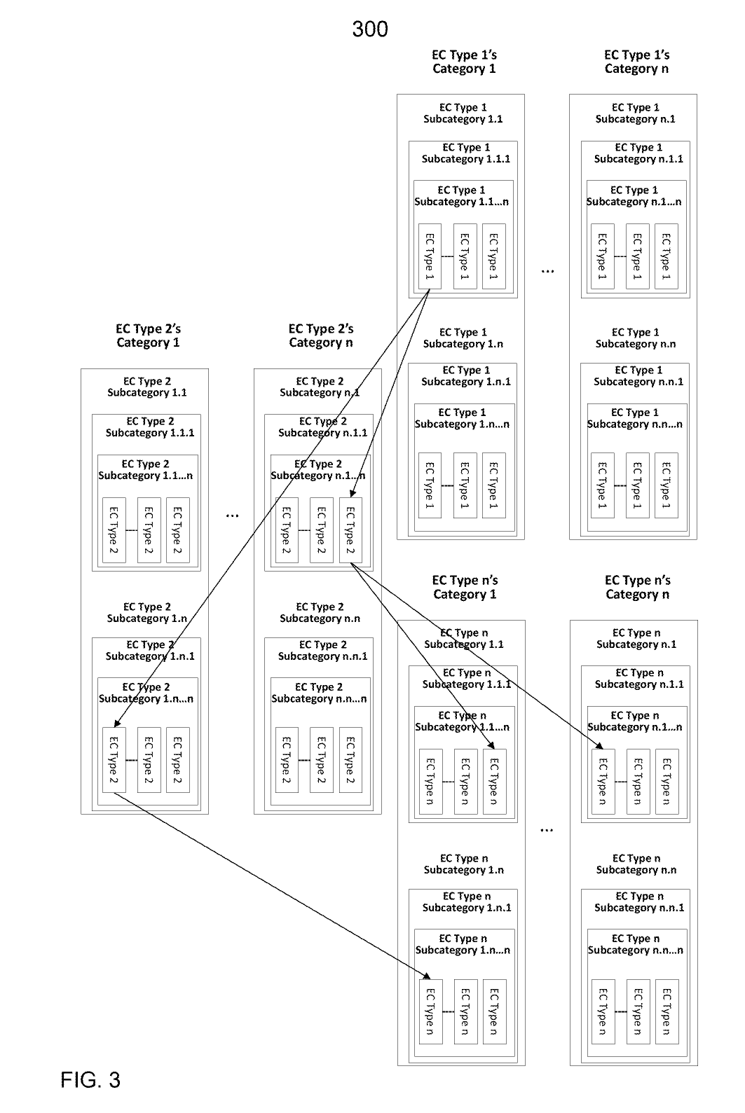

FIG. 3 is a block diagram of Repository of Educational Components used in a system for storing Educational Components and determining the alignment of Education Content to one or more Education Standards in accordance with some embodiments. The Repository of Educational Components may include Educational Components grouped into different types to indicate the different nature and priorities of the requirements carried in the Educational Components in representing the Education Standards through the analysis of Education Standards by the administrator and/or authorized education experts 102. The Education Components can further be grouped into one or more categories and one or more subcategories within each type. Referring to FIG. 3, the Repository of Educational Components includes Type 1 Educational Components, Type 2 Educational Components up to Type n Educational Components (where n is any number of Educational Component Type). Types of Educational Components can include such as Concept components, Skill components, Demonstration components or any other types of Educational Components. In the embodiment shown in FIG. 3, example of Type 1 Educational Components can be Concept components, and example of Type 2 Educational Components can be Skill components.

Embodiments of the Repository of Educational Components include that each Educational Component Type may be categorized in a specific manner, similar or in a different manner as the other Educational Component. In the embodiment shown in FIG. 3, each Educational Component Type is categorized in a similar manner. Further, the categorization of each Educational Component Type may include several categories (n number of categories) and several levels of subcategories (i.e. n number of levels of subcategories) with each level of subcategories having itself several subcategories (n number of subcategories).

In one embodiment, a selection of different types of Educational Components by a user to create an Education Content Identifier to represent a piece of Education Content may be independent of each other. That is, an Educational Component of Type 1 may be selected and any Educational Component of Type 2 may be selected independent of which Type 1 Educational Component was selected a priori. In another embodiment, selection of different types of Educational Components are dependent of each other. That is, upon selecting an Educational Component of Type 1, the user is allowed to select only among a subgroup of Educational Components of Type 2. Referring to FIG. 3, the directions of the arrows suggest that the selection of an Educational Component of Type 1 in this example of FIG. 3 would allow the selection of Educational Components of Type 2 in a limited subgroup within Type 2 rather than any Educational Components in the broader group of Type 2, and the same indication when the arrows go from Educational Components of Type 2 to the subsequent types.

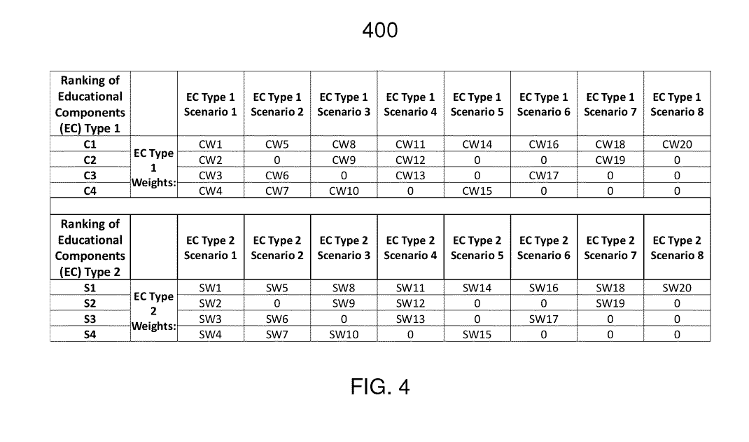

FIG. 4 is a chart illustrating an example of weight assignment scenarios for Educational Components comprising and Education Standard Identifier, in accordance with some embodiments. In the embodiment shown in FIG. 4, there are two types of Educational Components and four rankings for Type 1 Educational Components and four rankings for Type 2 Educational components, together creating 8 scenarios for assigning weights amount Educational Components in Type 1 based on their respective rankings and 8 scenarios for assigning weights amount Educational Components in Type 2 also based on their respective rankings. In the embodiment shown in FIG. 4, the Educational Component Type 1 can be Concept Components and Educational Component Type 2 can be Skill Components. Ranking C1 is set for a highly important concept addressed by the Education Standard, ranking C2 is set for an important concept, ranking C3 is set for a concept addressed but not as important, and ranking C4 is set for a concept touched upon by the Education Standard but not important at all. Further, ranking S1 is set for a highly important skill required by the Education Standard, ranking S2 is set for an important skill required by the Education Standard, ranking S3 is set for a skill addressed by the Education Standard but not as important, and ranking S4 is set for a Skill touched upon by the Education Standard but not important at all. Although a system administrator configures four rankings for Educational Components of Type 1 and four rankings for Educational Components of Type 2 in the embodiment depicted in FIG. 4, other embodiments may be configured such that Educational Components of Type 1 may have a different number of rankings as Educational Components of Type 2. Further embodiments may include Educational Components of Type 3, Type 4 . . . Type N (where N is any number) such as demonstration Educational Components and other Educational Components. Such Educational Component types are each configured with a number of rankings, the same or different from one another.

In the embodiment shown in FIG. 4, a system administrator can create one or more Educational Components of Type 1 and Educational Components of Type 2 and rank them in C1-C4 and S1-S4 positions respectively to create various combinations (e.g. scenarios) of Educational Components to represent an Education Standard. Each combination carries at least one Educational Component of Type 1 and one Educational Component of Type 2, and if there are only one Educational Component of Type 1 and one Educational Component of Type 2 in a combination, each Educational Component is defaulted in C1 and S1 rank positions respectively.

The Correlating System (Refer FIG. 1) assigns a different numerical value (“weight”) to each ranking based on the absence and presence of Educational Components in all the rankings in each combination created/configured by the administrator. The Educational Component ranked in that ranking thus captures the weight value assigned to that ranking to indicate the importance of the Educational Component in the Education Standard. Each combination thus created becomes a unique identifier (“Education Standard Identifier”) representing the Education Standard it is based on and is stored in the Repository of Education Standard Identifiers on the server.

If the system administrator ranks multiple Educational Components in the same ranking of importance, the Correlating System identifies the weight assigned to that ranking based on the scenarios, for example in FIG. 4, and equally distributes the weight among the Educational Components in that ranking. For example, to represent a selected Education Standard, the system administrator selects one Educational Component of Type 1 and ranks it in ranking C1, four Educational Components of Type 1 and ranks them all in the same ranking C2, and another Educational Component of Type 1 and ranks it in ranking C4. The scenario thus matched is Type 1 Scenario 3 as shown in FIG. 4. Each of the four Educational Components of Type 1 in ranking C2 then captures one fourth (or 25 percent) of the weight CW9, which is the weight for ranking C2 in the Type 1 Scenario 3.

Further, the sum of the weights in any scenario, across Educational Component Types, equals 100%. For example, in Scenario 1 of the example in FIG. 4, the sum of CW1, CW2, CW3, CW4, SW1, SW2, SW3, and SW4 equals 100%. In another example, in scenario 2, CW5, CW6, CW7, SW5, SW6, and SW7 also equals 100%. The weights can be configured such that the sum of the Type 1 weights are equal to a certain percentage and the Type 2 weights are equal to another percentage with the total summed up to 100% to reflect the hierarchical importance of each type of Educational Components in representing the Education Standards of any particular set. Such percentages are configurable. If another type of Educational Components is configured (e.g. Demonstration), the split of the total 100% weight is adjusted accordingly.

Further, the same scenario number may not be used for every Educational Component Type to generate an Education Standard Identifier. That is, an Educational Standard may have four Educational Components of Type 1 (Scenario 1) but only three Educational Components of Type 2 (either scenario 2, scenario 3, or scenario 4).

Further, although the embodiments shown in FIG. 4 shows only eight scenarios for each of Educational Components Type 1 and Educational Component Type 2, other embodiments may have a different number of scenarios. Moreover, each Educational Component Type may have a different number of scenarios as the other Educational Component Types. (e.g. Educational Component Type 1 may have eight scenarios but Educational Component Type 2 may have two scenarios) because of the different number of rankings configured for the respective types.

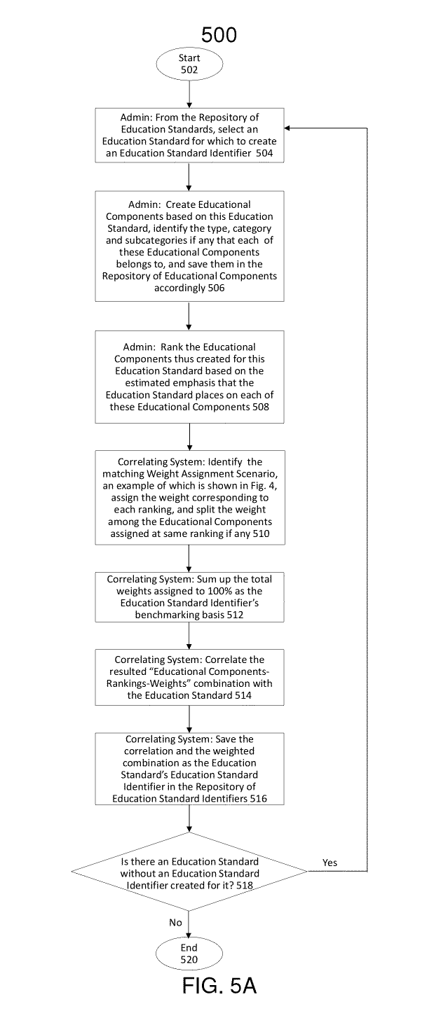

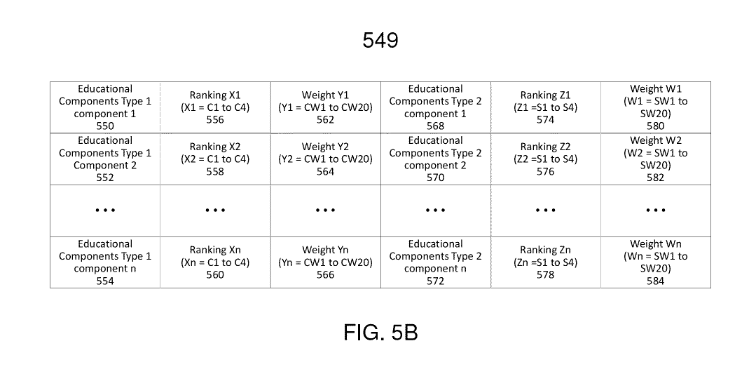

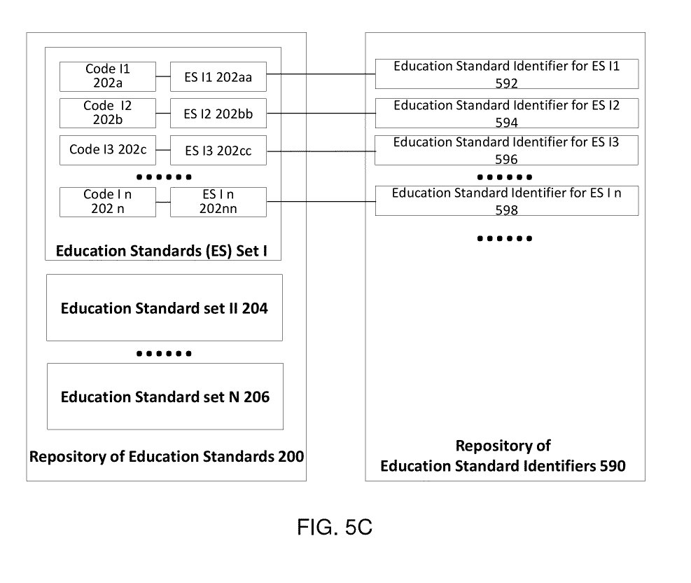

FIG. 5A is an embodiment of a method 500 for generating an Education Standard Identifier and Educational Components, in accordance with some embodiments. The method 500 includes an administrator (through an admin interface (See FIG. 1B)) selecting an Education Standard from the Repository of Education Standards for which to create/generate an Education Standard Identifier, as shown in block 504. Further, the method includes the administrator creating Educational Components based on the selected Education Standard, identifying the type, category and subcategories (if any) that each of the Educational Components belongs to, and saving Educational Components as well as the type, category, and subcategories (if any) in the Repository of Educational Components, accordingly, as shown in block 506. In addition, the administrator ranks the Educational Components created for the Education Standard based on the estimated emphasis that the Education Standard places on each Educational Component, as shown in block 508.

Moreover, the method 500 includes the correlating system (See FIG. 1B) identifying the matching Weight Assignment Scenario (see example in FIG. 4), assigning the weight corresponding to each ranking, and splitting the weight among the Educational Components assigned at same ranking (if any), as shown in block 510. Further, the method 500 includes the correlating system summing up the total weights assigned to 100% as the Education Standard Identifier's benchmarking basis, as shown in block 512. In addition, the method 500 further includes the correlating system correlating the resulted “Educational Components-Rankings-Weights” combination with the Education Standards, as shown in block 514. Also, the method 500 includes the correlating system saving the correlation and the “Educational Components-Rankings-Weights” combination as the Education Standard's Education Standard Identifier in the Repository of Education Standard Identifiers, as shown in block 516. Further, the method 500 includes determining whether there is an Education Standard without an Education Standard Identifier created for it, as shown in block 518. If so, the method 500 continues to block 504. Otherwise, the method 500 continues to block 520. In one embodiment, the steps of method 500 may be implemented by the system shown in FIG. 1B including the admin module and correlating system.

Further, each generated Educational Component in the Repository of Educational Components is based on the decomposition of at least one Education Standard in the Repository of Education Standard and thereby associated with at least one Education Standard. Otherwise, if the system determines an Educational Component in the Repository of Educational Components that is not associated with an Education Standard, the system deletes the Educational Component from the Repository of Educational Components.

Although, in one embodiment, the blocks 504, 506, and 508 may be performed based on the input from an administrator, other embodiments may have blocks, 504, 506, and 508 be performed in automated fashion by one or more computer servers implementing the system (See FIG. 1B). For example, when a set of Education Standards is uploaded in the system, the system may “read,” the “decide” or “decompose” the Educational Components of each Education Standard in each the set of Education Standards (based on algorithms and Educational Component templates of Educational Components stored and implemented by the system). Further the system may be configured to rank the Educational Components, assign weights and then generate and store an Education Standard Identifier associated with each Education Standard in the set of Education Standards without user input from an administrator.

As an example of method 500, an administrator may select an Education Standard, “Interpret products of whole numbers, e.g., interpret 5×7 as the total number of objects in 5 groups of 7 objects each.” from the set of Common Core State Standards for Math. The administrator may decompose a Concept component (e.g. Educational Component of Type 1), “Whole number multiplication and division,” and configure it as a ranking C1. Further, the administrator may determine there are no more Concept components for this Education Standard. The administrator may then decompose a Skill component (e.g. Educational Component of Type 2), “Interpreting multiplication as finding the sum of total objects in different groups with the same number per group,” and configure it as a ranking S1. In addition, the administrator may determine there are no more Skill components for this Education Standard. Moreover, the correlating system identifies scenario 8 for both Type 1 and Type 2 in FIG. 4 and assigns the weights to each Educational Component accordingly. In this example, the weight for the Concept component is CW20 in FIG. 4 and the weight of the skill component is SW20 in FIG. 4. The correlating system associates or correlates the Educational Components-Rankings-Weights combination with the Education Standard. Further, an Education Standard Identifier is generated based on this Educational Components-Rankins-Weights combination and stored in the Repository of Education Standard Identifiers. Further embodiments of method 500 may decompose Education Standards into not only Type 1 or Type 2 Educational Components but also one or more additional types of Educational Components.

FIG. 5B, is a chart illustrating an example structure of an Education Standard Identifier 549 in view of scenarios in FIG. 4, in accordance with some embodiments. The example Education Standard Identifier shown in FIG. 5B may be for an Education Standard with “n” number of Educational Components of Type 1 (e.g. Concept Educational Components) having a ranking basis of four ranks, C1, C2, C3, and C4, eight weight assignment scenarios as shown in FIG. 4 such that the weights assigned to Educational Components in each rank range from CW1 to CW20. Further, the example Education Standard Identifier 549 show in FIG. 5B may be for an Education Standard with “n” number of Educational Components of Type 2 (e.g. Skill Educational Components) having a ranking basis of four ranks, S1, S2, S3, and S4, eight weight assignment scenarios as shown in FIG. 4 such that the weights assigned to Educational Components in each rank range from SW1 to SW20.

Moreover, the example Education Standard Identifier 549 may be a two dimensional array of six columns and “n” rows to comprise an “Educational Components-Rankings-Weights” combination as described herein. The first three columns of the first row lists the first Educational Component of Type 1 (e.g. Concept) 550, the ranking X1 of the Educational Component 556 (between C1 and C4) and the weight Y1 of the Educational Component (between CW1 and CW20) 562 based on the scenarios in FIG. 4. Further, the first three columns of the second row lists the second Educational Component of Type 1 (e.g. Concept) 552, the ranking X2 of the Educational Component 558 (between C1 and C4) and the weight Y2 of the Educational Component (between CW1 and CW20) 564 based on the scenarios in FIG. 4. The array continues to list the “Educational Components-Rankings-Weights” combination for Educational Component of Type 1 in the Education Standard. The example Education Standard Identifier 549 shows that there may be “n” number of Educational Components of Type 1. Moreover, the first three columns of the last row lists the last Educational Component of Type 1 (e.g. Concept) 554, the ranking Xn of the Educational Component 560 (between C1 and C4) and the weight Yn of the Educational Component (between CW1 and CW20) 566 based on the scenarios in FIG. 4.

Further, the last three columns of the first row lists the first Educational Component of Type 2 (e.g. Skill) 568, the ranking Z1 of the Educational Component 574 (between S1 and S4) and the weight W1 of the Educational Component (between SW1 and SW20) 580 based on the scenarios in FIG. 4. Further, the last three columns of the second row lists the second Educational Component of Type 2 (e.g. Skill) 570, the ranking Z2 of the Educational Component 576 (between S1 and S4) and the weight W2 of the Educational Component (between SW1 and SW20) 582 based on the scenarios in FIG. 4. The array continues to list the “Educational Components-Rankings-Weights” combination for each Educational Component of Type 2 in the Education Standard. The example Education Standard Identifier 549 shows that there may be “n” number Educational Component of Type 2. Moreover, the last three columns of the last row lists the last Educational Component of Type 2 (e.g. Skill) 572, the ranking Zn of the Educational Component 578 (between S1 and S4) and the weight Wn of the Educational Component (between SW1 and SW20) 566 based on the scenarios in FIG. 4. Note the number of Educational Components of Type 1 and the number of Educational Components of Type 2 need not be the same. Further, although the example Education Standard Identifier 549 generated for an Education Standard that includes two Educational Component Types, a ranking basis of four rankings for each Educational Component Type, and eight weight assignment scenarios for each Educational Component Type (based on FIG. 4), other embodiments may include different number of Educational Component types, different number of Educational Components for each type, different ranking basis for each Educational Component Type, and different weight assignment scenarios (other than those shown in FIG. 4). Thus, the range of each variable n, X1 to Xn, Y1 to Yn, Z1 to Zn, and W1 to Wn may vary accordingly.

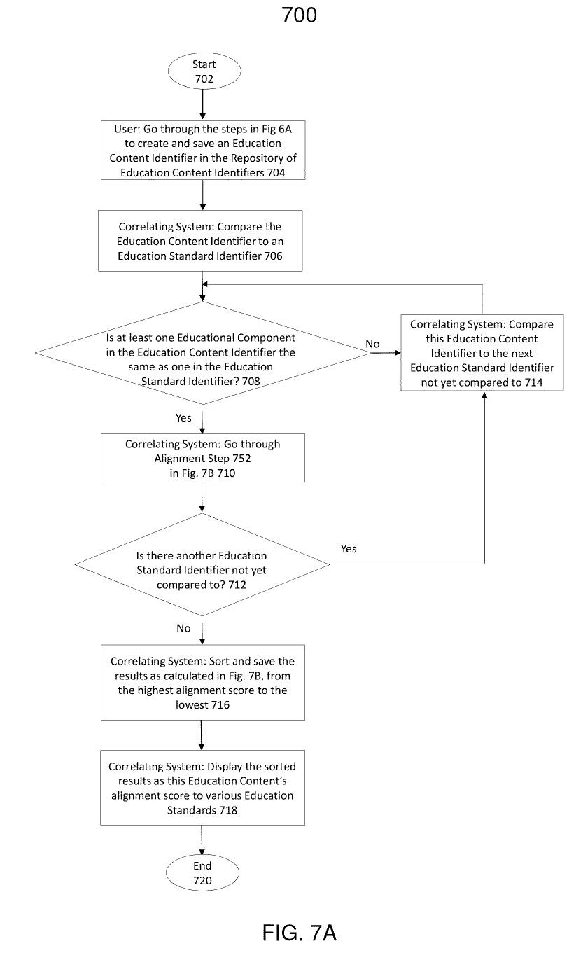

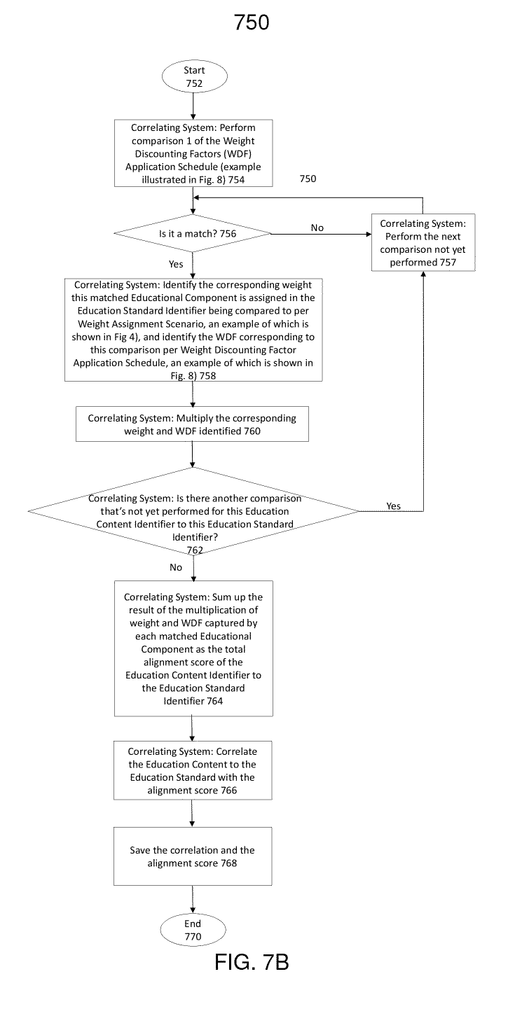

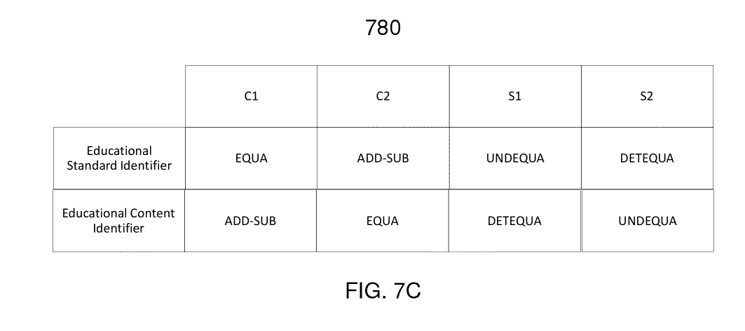

For example, to represent standard 1.OA.7 of the Common Core State Standards for Math—“Understand the meaning of the equal sign, and determine if equations involving addition and subtraction are true or false. For example, which of the following equations are true and which are false? 6=6, 7=8−1, 5+2=2+5, 4+1=5+2”, an authorized education expert as the system administrator may create and rank the following Educational Components: “equation” (“EQUA”) as a highly important concept and thus ranks it “C1”, “Whole number addition and subtraction” (“ADD-SUB”) as an important concept and thus ranks it “C2”, “Understanding the meaning of equal sign” (“UNDEQUA”) as a highly important skill and thus ranks it “S1”, and “Determining if equation is true or false” (“DETEQUA”) as an important skill and thus ranks it “S2”. The Correlating System assigns a weight to each component when the creation followed by ranking is completed and adds all the final weights assigned as the Education Standard's total weight, to be benchmarked upon for the Education Content to compare to in the alignment process detailed in FIG. 7A and FIG. 7B. Per the scenarios in FIG. 4, the Correlating System identifies Concept Scenario 7, which is C1“yes”-C2 “yes”-C3 “no”-C4 “no” scenario for the Concept components combination and Skill Scenario 7 in FIG. 4, which is S1 “yes”-S2 “yes”-S3 “no”-S4 “no” scenario for the Skill components combination, and thus assigns weight CW18 to Concept component in C1—“EQUA”, weight CW19 to Concept component in C2—“ADD-SUB”, weight SW18 to Skill component in S1—“UNDEQUA”, and weight SW19 to Skill component in S2—“DETEQUA”. The weighted combination “EQUA:C1:CW18—ADD-SUB:C2:CW19—UNDEQUA:S1:SW18—DETEQUA:S2:SW19” thus created is the Education Standard Identifier to represent Common Core State Standard for Math standard 1.OA.7, and is correlated to the standard 1.OA.7 and saved in the Repository of Education Standard Identifiers.

Although the embodiment of the Education Standard Identifier includes representations of Concept components and Skill components as Educational Component Types, other embodiments may include representations of any combination of Concepts, Skills, demonstrations, and/or other components as Educational Component Types.

FIG. 5C is a block diagram showing Education Standard Identifiers correlated to Education Standards, in accordance with some embodiments. The Repository of Education Standards in FIG. 2 is shown. Further, a Repository of Education Standard Identifiers 590 is also shown having Education Standard Identifiers (592-598). A system (See FIG. 1B) correlates (i.e. associates, links, couples, etc. and stores such correlation, association, link, or coupling in the system) each Education Standard Identifier (592-598) stored in the Repository of Education Standard Identifiers to an Education Standard in the Repository of Education Standards. Thus, the Education Standard Identifier for Education Standard I1 592 is correlated to Education Standard I1 202aa. Further, the Education Standard Identifier for Education Standard I2 594 is correlated to Education Standard I2 202bb. In addition, the Education Standard Identifier for Education Standard I3 596 is correlated to Education Standard I3 202cc. Moreover, the Education Standard Identifier for Education Standard In 598 is correlated to Education Standard In 202nn.

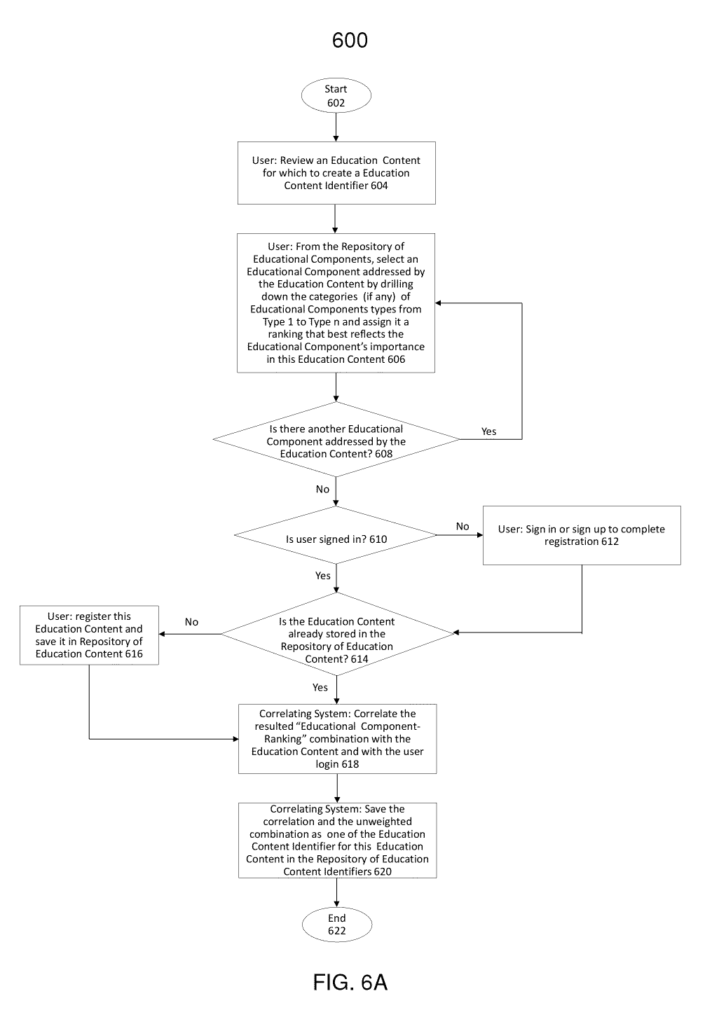

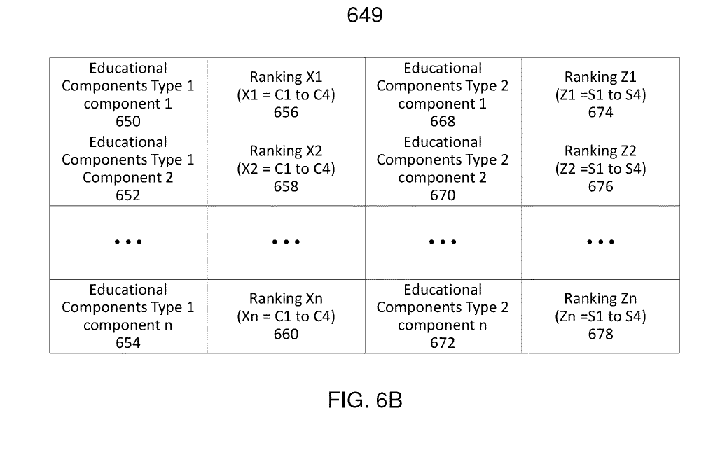

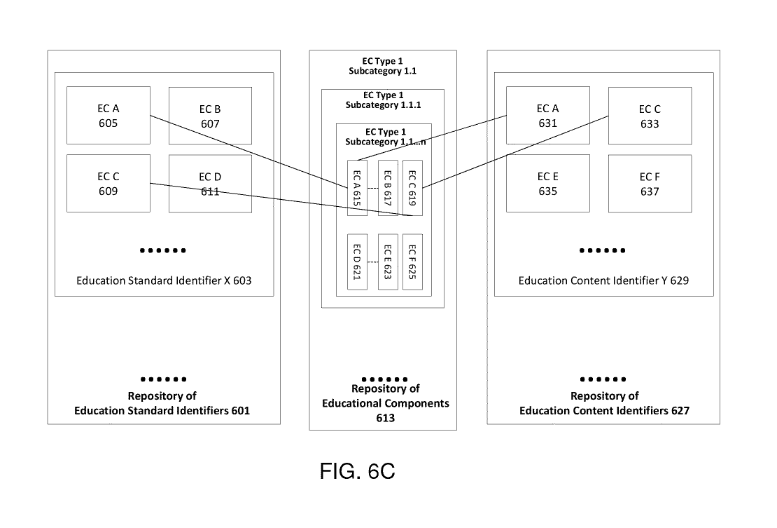

FIG. 6A is an embodiment of a method 600 for generating an Education Content Identifier, in accordance with some embodiments. The method 600 includes a user reviewing Education Content that may be stored in the Repository of Education Content in a system (See FIG. 1B) to create an Education Content Identifier, as shown in block 604. The user may upload and review or access from a Repository of Education Content and review such Education Content from a user computing device through a User interface. Further, the method 600 includes a user selecting, from the Repository of Educational Components, an Educational Component addressed by the Education Content by drilling down the categories (if any) of Educational Component types from Type 1 to Type n and assign the selected Educational Component a ranking that best reflects the Educational Component's importance to the Education Content, as shown in block 606. In addition, the method 600 includes the user determining whether another Educational Component is addressed by the Educational Content, as shown in block 608. If so, the method 600 continues to block 606. If not, the system determines whether the user is sign or logged into the system, as shown in block 610. If the user is not signed, then the user is prompted to sign in by the system or requested to register with the system, as shown in block 612. After the user signs in or registers (612) or if the user is already signed in, the method 600 includes the system determines whether the Education Content is already stored in the Repository of Education content, as shown in block 614. If not, the user registers the Education Content and saves the Education Content in the Repository of Education Content 616. After saving the Education Content in the Repository of Education Content (616) or determined that the Education was already saved, the method 600 includes the correlating system correlating the resulting “Educational Component-Ranking” combination with the Education Content and with the user login information, as shown in block 618. The method 600 further includes the correlating system saving the correlation and the unweighted “Educational Component-Ranking” combination as one of the Education Content Identifiers for the Education Content in the Repository of Education Content Identifiers, as shown in block 620. In one embodiment, the steps of method 600 may be implemented by the system shown in FIG. 1B including the user module and correlating system.

In one embodiment, the user may select an Educational Component of any type at first to generate an Education Content Identifier. In other embodiments, the user may be selecting an Educational Component of a certain type at first. Then, based on the certain type of Educational Component first selected, the user may then select an Educational Component from a subgroup of Educational Components of a different type. Thus, in such embodiments, the selection of Educational Components may be dependent of prior selection of Educational Components of a different type.

Although, some embodiments of method 600 an Education Content Identifier may be generated by user input, other embodiments of method 600 include generation of the Education Content Identifier with limited or no user input. Instead, the system may implement algorithms, functions, or modules that review and analyze the Education Content, and determine the Educational Components addressed by the Education Content, and ranks the Educational Components thereby generating an Education Content Identifier without or with limited user input.

FIG. 6B is chart illustrating an example structure of an Education Content Identifier 649, in accordance with some embodiments. The example Education Content Identifier shown in FIG. 6B may be for Education Content with “n” number of Educational Components of Type 1 (e.g. Concept Educational Components) having a ranking basis having four ranks, C1, C2, C3, and C4. Further, the example Education Content Identifier 649 show in FIG. 6B may be for Education Content with “n” number of Educational Components of Type 2 (e.g. Skill Educational Components) having a ranking basis having four ranks, S1, S2, S3, and S4.

Moreover, the example Education Content Identifier 649 may be a two dimensional array of four columns and “n” rows to comprise an “Educational Component-Rank” combination as described herein. The first two columns of the first row lists component 1 of Educational Component Type 1 (e.g. Concept) 650 and the ranking X1 of the Educational Component 656 (between C1 and C4). Further, the first two columns of the second row lists component 2 of Educational Component Type 1 (e.g. Concept) 652 and the ranking X2 of the Educational Component 658 (between C1 and C4). The array continues to list the “Educational Component-Rank” combination for each component of Educational Component Type 1 in the Education Content. The example Education Content Identifier 649 shows that there may be “n” number of components of Educational Component Type 1. Moreover, the first two columns of the last row lists component n of Educational Component Type 1 (e.g. Concept) 654 and the ranking Xn of the Educational Component 660 (between C1 and C4).

Further, the last two columns of the first row lists component 1 of Educational Component Type 2 (e.g. Skill) 668 and the ranking Z1 of the Educational Component 674 (between S1 and S4). Further, the last two columns of the second row lists component 2 of Educational Component Type 2 (e.g. Skill) 670 and the ranking Z2 of the Educational Component 676 (between 51 and S4). The array continues to list the “Educational Component-Rank” combination for each component of Educational Component Type 2 in the Education Content. The example Education Content Identifier 649 shows that there may be “n” number of components of Educational Component Type 2. Moreover, the last two columns of the last row lists component n of Educational Component Type 2 (e.g. Skill) 672 and the ranking Zn of the Educational Component 678 (between S1 and S4). Note the number of Educational Components of Type 1 and the number of Educational Components of Type 2 need not be the same. Further, although the example Education Content Identifier 649 generated for Education Content that includes two Educational Component Types and a ranking basis of four ranking for each Educational Component Type, other embodiments may include different Educational Component types, different number of components of each Educational Component Type, and different ranking basis for each Educational Component Type. Thus, the range of each variable n, X1 to Xn, and Z1 to Zn may vary accordingly.

For example, the developer of a mobile application (i.e. piece of Education Content) that requires children to identify numbers to make an equation or scale stay balanced may select and rank the following Educational Components to represent an evaluation of the piece of Education Content: “EQUA” and ranks it in C1, “ADD-SUB” in C2, “UNDEQUA” in S1, and “DETEQUA” in S2. The unweighted Educational Component-ranking combination “EQUA:C1—ADD-SUB:C2—UNDEQUA:S1—DETEQUA:S2” is the content's one Education Content Identifier, and is correlated to the content represented and saved in the Repository of Education Content Identifiers on a computer server.

FIG. 6C is a block diagram describing the Educational Components' correlation to Education Standard Identifiers and to Education Content Identifier, in accordance with some embodiments. An Education Standard Identifier X 603 is stored in the Repository of Education Standard Identifiers 601. The Education Standard Identifier X 603 list four Educational components, Educational Component A 605, Educational Component B 607, Educational Component C 609, and Educational Component D 611. Further, Educational Components A-D (615-625) of Educational Component Type 1 are stored in the Repository of Educational Components 613. In addition, an Education Content Identifier Y 520 stored in the Repository of Education Content Identifiers 627 lists four Educational Components, Educational Component A 631, Educational Component C 633, Educational Component E 635, and Educational Component F 637. As shown in FIG. 6C, Educational Component A 605 of the Education Standard Identifier X 603 is correlated (i.e. associated, linked, coupled) to Educational Component A 615 of Educational Component Type 1. Further, Educational Component A 631 of the Education Content Identifier Y 629 is correlated (i.e. associated, linked, coupled) to Educational Component A 615 of Educational Component Type 1. Thus, Educational Component A 605 of the Education Standard Identifier X 603 is correlated (i.e. associated, linked, coupled) to Educational Component A 631 of the Education Content Identifier Y 629. Similarly, Educational Component C 609 of the Education Standard Identifier X 603 is correlated (i.e. associated, linked, coupled) to Educational Component C 619 of Educational Component Type 1. Further, Educational Component C 633 of the Education Content Identifier Y 629 is correlated (i.e. associated, linked, coupled) to Educational Component C 619 of Educational Component Type 1. Thus, Educational Component C 609 of the Education Standard Identifier X 603 is correlated (i.e. associated, linked, coupled) to Educational Component C 633 of the Education Content Identifier Y 629.

FIGS. 7A-7B are flowcharts of methods of aligning Education Content to Education Standards and determining the degree of such alignment, in accordance with some embodiments. Referring to FIG. 7A, the method 700 identifies the Education Standards for aligning with Education Content. The method 700 includes a user creates/generates and saves an Education Content Identifier in the Repository of Education Content Identifiers according to FIG. 6A, as shown in block 704. Further, the method 700 includes the correlating system comparing the Education Content Identifier to and Education Standard Identifier, as shown in block 706. In addition, the system determines whether at least one Educational Component in the Education Content Identifier is the same (or in common) as an Educational Component in the Education Standard Identifier, as shown in block 708. If not, the method 700 includes comparing the Education Content Identifier to the next Education Standard Identifier not yet compared, as shown in block 714. If so, the method 700 includes the correlating system implement the alignment step 752 in FIG. 7B, as shown in block 710. In addition, method 700 includes the system determining whether another Education Standard Identifier is not yet compared to the Education Content Identifier, as shown in block 712. If so, the method 700 continues to block 714. If not, the method 700 includes the correlating system sorting and saving the results calculated in the method shown in FIG. 7B from the highest alignment score to the lowest alignment score, as shown in block 716. Moreover, the method 700 includes the correlating system display the sorted results as the Education Content's alignment score to various Education Standards, as shown in block 718. In one embodiment, the steps of method 700 may be implemented by the system shown in FIG. 1B including the user module and correlation system.

Note, the Repository of Educational Components was generated by decomposing Education Standards, and each Education Standard includes at least one Educational Component. Further, an Education Standard Identifier is generated for each Education Standard. Thus, each Educational Component in the Repository of Educational Components is listed in at least one Education Standard Identifier. Moreover, an Education Content Identifier lists Educational Components selected from the Repository of Educational Components. Thus, an Educational Component listed in the Education Content Identifier must be listed in at least on Education Standard. Therefore, with regard to block 708, eventually the system finds a common Educational Component listed in both the Education Content Identifier and an Education Standard Identifier such that the method continues to block 710 and progresses the end instead of continually looping through block 714.

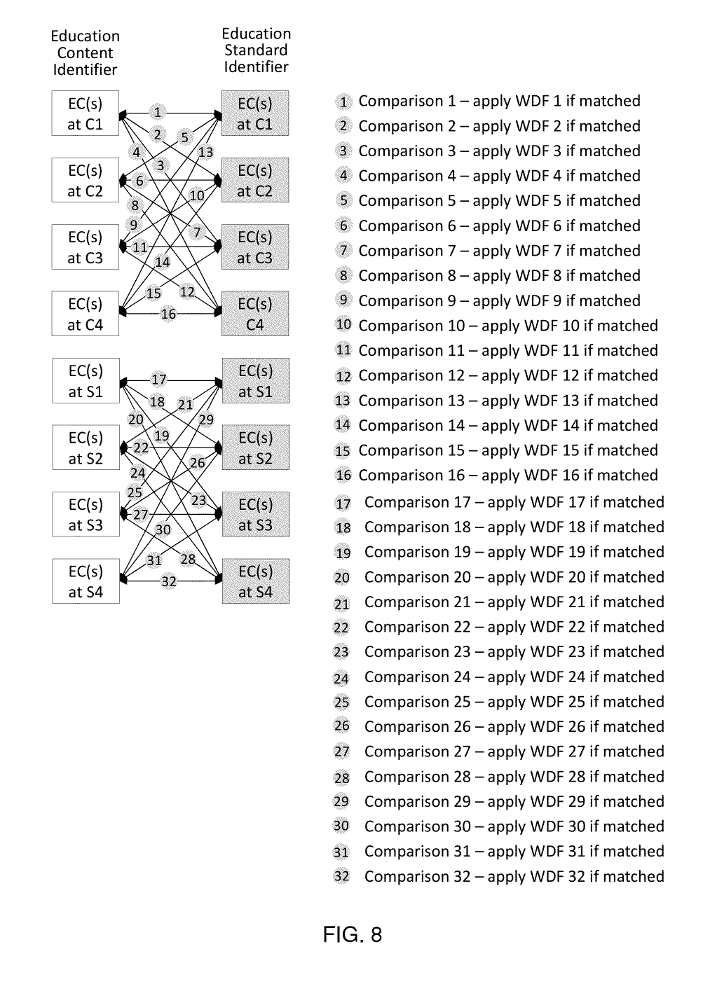

Referring to FIG. 7B, a method 750 is a method for calculating the percentage alignment between Education Content and an Education Standard. The method 750 includes the correlating system performing comparison 1 of the weight discounting factors (WDF) Application Schedule (example shown in FIG. 8), as shown in block 756. Further, the method 700 includes the correlating system determining whether there is a match between Educational Components in the Education Standard Identifier and the Education Content Identifier, as shown in block 756. If not, the method 750 includes the correlating system performs the next comparison (See FIG. 8) not yet performed, as shown in block 757. If so, the method 750 includes the correlating system identifying the corresponding weight the matched Educational Component is assigned in the Education Standard Identifier being compared pursuant to the Weight Assignment scenario and identify the WDF corresponding to this comparison per the Weight Discounting Factor Application Schedule (See FIG. 8), as shown in block 758, The method 750 additionally includes the correlating system multiplying the corresponding weight and WDF identified, as shown in block 760. The method 750 includes the correlating system determining whether there is another comparison that is not yet performed for the Education Content Identifier to the Education Standard Identifier, as shown in block 762. If so, the method 750 continues to block 757. If not, the correlating system sums up the result of the multiplication of weight and WDF captured by each matched Educational Component as the total alignment score of the Education Content Identifier to the Education Standard Identifier, as shown in block 764. Further, method 750 includes the correlating system correlating (i.e. associating, linking, coupling, etc.) the Education Content to the Education Standard with the alignment score, as shown in block 766. Moreover, the method 750 includes saving the correlation and the alignment score in a database coupled to the system, as shown in block 768. In one embodiment, the steps of method 750 may be implemented by the system shown in FIG. 1B including the correlation system.

FIG. 7C is a chart comparing an Education Content Identifier to an Education Standard Identifier, in accordance with some embodiments. For example, an Education Standard may be, “Understand the meaning of the equal sign, and determine if equations involving addition and subtraction are true or false that includes determining which of the following equations are true and which are false? 6=6, 7=8−1, 5+2=2+5, 4+1=5+2,” with Standard Code 1.OA.7. Its Education Standard Identifier may be EQUA:C1:CW18—ADD-SUB:C2:CW19—UNDEQUA:S1:SW18—DETEQUA:S2:SW19 (See FIG. 7C and also FIG. 5B and associated description). Such an Education Standard has two concept components, EQUA and ADD-SUB, ranked C1 and C2 with weights CW18 and CW19, respectively as well as two skill components, UNDEQUA and DETEQUA, ranked S1 and S2 with weights SW18 and SW19, respectively. Further, there may be a piece of Education Content that includes concept components EQUA and ADD-SUB and skill components UNDEQUA and DETEQUA. However, a user ranks ADD-SUB as C1 and EQUA as C2 as well as ranks DETEQUA as S1 and UNDEQUA as S2. The method 750 identifies that all four Educational Components are matched to the Education Standard with standard code 1.OA.7. However, the rankings for each of concept components and skill components are in reverse order (See FIG. 7C).

As part of the alignment process or method 750, if matched component is ranked in a first rank position in the Education Content Identifier, in the same rank position in both the Education Content Identifier and the Education Standard Identifier or in a higher rank position in the Education Content Identifier than in the Education Standard Identifier then a weight discounting factor of 100% is applied. However, if a matched component is ranked lower in the Education Content Identifier than in the Education Standard Identifier then a weight discounting factor is applied.

In the example shown in FIG. 7C, and referring to FIG. 8, the ADD-SUB component is ranked higher in the Education Content Identifier than the ADD-SUB component in the Education Standard Identifier. Such a comparison is comparison 2 in FIG. 8. Thus the WDF 2 is applied to the alignment score. However, the WDF is 100% because the common Educational Component is ranked higher in Education Content Identifier than in the Education Standard Identifier. Further, the UNDEQUA component is ranked higher in the Education Standard Identifier than the UNDEQUA component in the Education Standard Identifier. Such a comparison is comparison 5 in FIG. 8. Thus, the WDF 5 is applied to the alignment score.

FIG. 8 is an example weight discounting factors (WDF) Application Schedule. In FIG. 8, the weight discounting factors (WDFs) are defaulted in numerical values between 0 and 1 (or 0% to 100%) with 1 included and 0 not included. Some of the WDFs are of the same numerical value. Comparison 1 is to compare the Educational Component in C1 ranking of the content's Education Content Identifier with that in C1 ranking of the matched standard's Education Standard Identifier and apply WDF 1 if matched. Comparison 2 is to compare the Educational Component in C1 ranking of the content's Education Content Identifier with that in C2 ranking of the matched standard's Education Standard Identifier and apply WDF 2 if matched. Comparison 3 is to compare the Educational component in C1 ranking of the content's Education Content Identifier with that in C3 ranking of the matched standard's Education Standard Identifier and apply WDF 3 if matched. Comparison 4 is to compare the Educational Component in C1 ranking of the content's Education Content Identifier with that in C4 ranking of the matched standard's Education Standard Identifier and apply WDF 4 if matched.

Comparison 5 is to compare the Educational Component in C2 ranking of the content's Education Content Identifier with that in C1 ranking of the matched standard's Education Standard Identifier and apply WDF 5 if matched. Comparison 6 is to compare the Educational Component in C2 ranking of the content's Education Content Identifier with that in C2 ranking of the matched standard's Education Standard Identifier and apply WDF 6 if matched. Comparison 7 is to compare the Educational Component in C2 ranking of the content's Education Content Identifier with that in C3 ranking of the matched standard's Education Standard Identifier and apply WDF 7 if matched. Comparison 8 is to compare the Educational Component in C2 ranking of the content's Education Content Identifier with that in C4 ranking of the matched standard's Education Standard Identifier and apply WDF 8 if matched. Comparison 9 is to compare the Educational Component in C3 ranking of the content's Education Content Identifier with that in C1 ranking of the matched standard's Education Standard Identifier and apply WDF 9 if matched. Comparison 10 is to compare the Educational Component in C3 ranking of the content's Education Content Identifier with that in C2 ranking of the matched standard's Education Standard Identifier and apply WDF 10 if matched. Comparison 11 is to compare the Educational Component in C3 ranking of the content's Education Content Identifier with that in C3 ranking of the matched standard's Education Standard Identifier and apply WDF 11 if matched. Comparison 12 is to compare the Educational Component in C3 ranking of the content's Education Content Identifier with that in C4 ranking of the matched standard's Education Standard Identifier and apply WDF 12 if matched. Comparison 13 is to compare the Educational Component in C4 ranking of the content's Education Content Identifier with that in C1 ranking of the matched standard's Education Standard Identifier and apply WDF 13 if matched. Comparison 14 is to compare the Educational Component in C4 ranking of the content's Education Content Identifier with that in C2 ranking of the matched standard's Education Standard Identifier and apply WDF 14 if matched. Comparison 15 is to compare the Educational Component in C4 ranking of the content's Education Content Identifier with that in C3 ranking of the matched standard's Education Standard Identifier and apply WDF 15 if matched. Comparison 16 is to compare the Educational Component in C4 ranking of the content's Education Content Identifier with that in C4 ranking of the matched standard's Education Standard Identifier and apply WDF 16 if matched. Comparison 17 is to compare the Educational Component in S1 ranking of the content's Education Content Identifier with that in S1 ranking of the matched standard's Education Standard Identifier and apply WDF 17 if matched. Comparison 18 is to compare the Educational Component in S1 ranking of the content's Education Content Identifier with that in S2 ranking of the matched standard's Education Standard Identifier and apply WDF 18 if matched. Comparison 19 is to compare the Educational Component in S1 ranking of the content's Education Content Identifier with that in S3 ranking of the matched standard's Education Standard Identifier and apply WDF 19 if matched. Comparison 20 is to compare the Educational Component in S1 ranking of the content's Education Content Identifier with that in S4 ranking of the matched standard's Education Standard Identifier and apply WDF 20 if matched. Comparison 21 is to compare the Educational Component in S2 ranking of the content's Education Content Identifier with that in S1 ranking of the matched standard's Education Standard Identifier and apply WDF 21 if matched. Comparison 22 is to compare the Educational Component in S2 ranking of the content's Education Content Identifier with that in S2 ranking of the matched standard's Education Standard Identifier and apply WDF 22 if matched. Comparison 23 is to compare the Educational Component in S2 ranking of the content's Education Content Identifier with that in S3 ranking of the matched standard's Education Standard Identifier and apply WDF 23 if matched. Comparison 24 is to compare the Educational Component in S2 ranking of the content's Education Content Identifier with that in S4 ranking of the matched standard's Education Standard Identifier and apply WDF 24 if matched. Comparison 25 is to compare the Educational Component in S3 ranking of the content's Education Content Identifier with that in S1 ranking of the matched standard's Education Standard Identifier and apply WDF 25 if matched. Comparison 26 is to compare the Educational Component in S3 ranking of the content's Education Content Identifier with that in S2 ranking of the matched standard's Education Standard Identifier and apply WDF 26 if matched. Comparison 27 is to compare the Educational Component in S3 ranking of the content's Education Content Identifier with that in S3 ranking of the matched standard's Education Standard Identifier and apply WDF 27 if matched. Comparison 28 is to compare the Educational Component in S3 ranking of the content's Education Content Identifier with that in S4 ranking of the matched standard's Education Standard Identifier and apply WDF 28 if matched. Comparison 29 is to compare the Educational Component in S4 ranking of the content's Education Content Identifier with that in S1 ranking of the matched standard's Education Standard Identifier and apply WDF 29 if matched. Comparison 30 is to compare the Educational Component in S4 ranking of the content's Education Content Identifier with that in S2 ranking of the matched standard's Education Standard Identifier and apply WDF 30 if matched. Comparison 31 is to compare the Educational Component in S4 ranking of the content's Education Content Identifier with that in S3 ranking of the matched standard's Education Standard Identifier and apply WDF 31 if matched. Comparison 32 is to compare the Educational Component in S4 ranking of the content's Education Content Identifier with that in S4 ranking of the matched standard's Education Standard Identifier and apply WDF 32 if matched.

Although there are 32 comparisons shown in FIG. 8, with two Educational Component Types and a ranking basis of four ranks, FIG. 8 shows only one embodiment. The number of Education Component Types and the ranking basis can be varied such that the number of comparison can increase and decrease from the number of comparisons (e.g. 32) shown in FIG. 8.

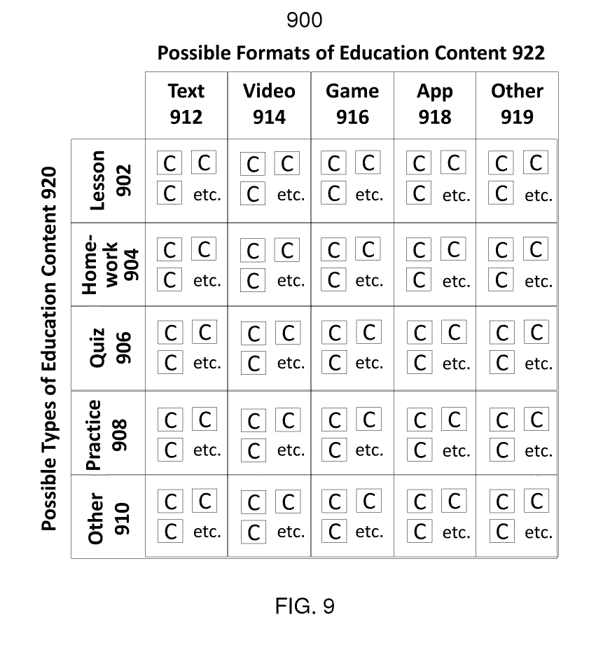

FIG. 9 is a block diagram of Repository of Education Content used in a system for storing Education Content and determining the alignment of Education Content to one or more Education Standards, in accordance with some embodiments. As a user completes aligning Education Content to the Education Standards by generating the Education Content Identifier for the Education Content, the system provides an option for the user to upload Education Content or provide a URL for other users to access the Education Content. If the user selects this option, the Education Content or Shared Education Content directory shared is saved in the Repository of Education Content on a computer server. The Repository of Education Content Identifiers directly connects (by correlation) to the Repository of Education Content and the Repository of Educational Components, and is the correlating system between the Education Content and the Educational Components. A link between the Education Content and a user's ID is also established, and such that the Education Content and its Education Content Identifier created under the same user ID are correlated. The user can identify Education Content by format 922—text 912, video 914, PC game 916, mobile application 918 or any other format—and by type 920—lesson plan 902, homework 904, quiz 906, practice 908, or other type 910. Further, other embodiments may include further content types and content formats not listed in FIG. 9.

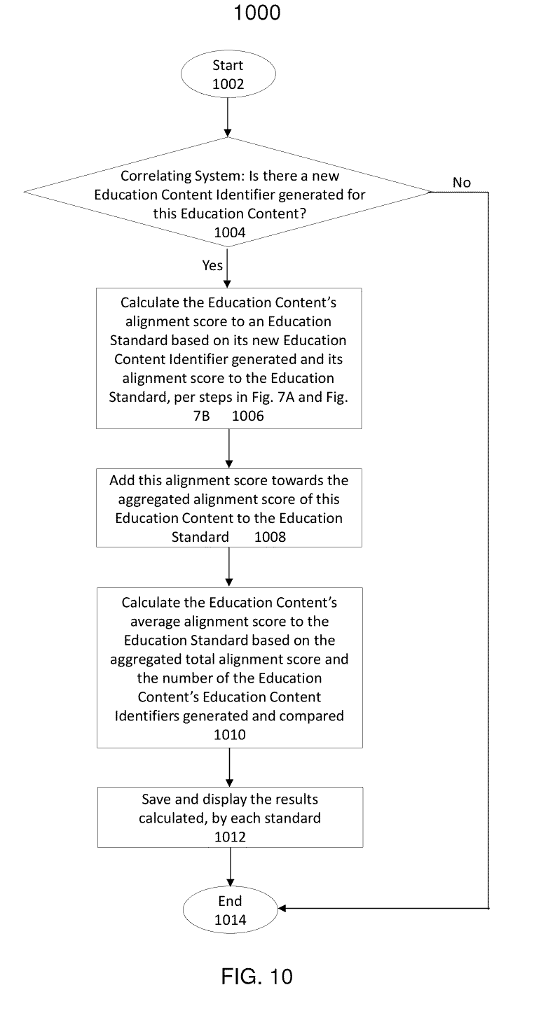

FIG. 10 is a flowchart of a method 1000 of calculating a piece of Education Content's average alignment score to one or more Education Standards, in accordance to some embodiments. Method 1000 includes the correlating system determining whether there is a new Education Content Identifier generation for a specific Education Content, as shown in block 1004. If not, the method 100 ends 1014. If not, the method 1000 further includes calculating the Education Content's alignment score to an Education Standard based on the new Education Content Identifier alignment score to the Education Standard according to the methods shown in FIGS. 7A and 7B, as shown in block 1006. In addition, the method 1000 adds this alignment score towards the aggregated alignment score of this Education Content to the Education Standard, as shown in block 1008. The method 1000 also includes calculating the Education Content's average alignment score to the Education Standard based on the aggregated total alignment score and the number of Education Content's Education Content Identifiers generated and compared, as shown in block 1010. Further, the method 1000 includes saving and displaying the results calculated, by each standard, as shown in block 1012. In one embodiment, the steps of method 1000 may be implemented by the system shown in FIG. 1B including correlation system.

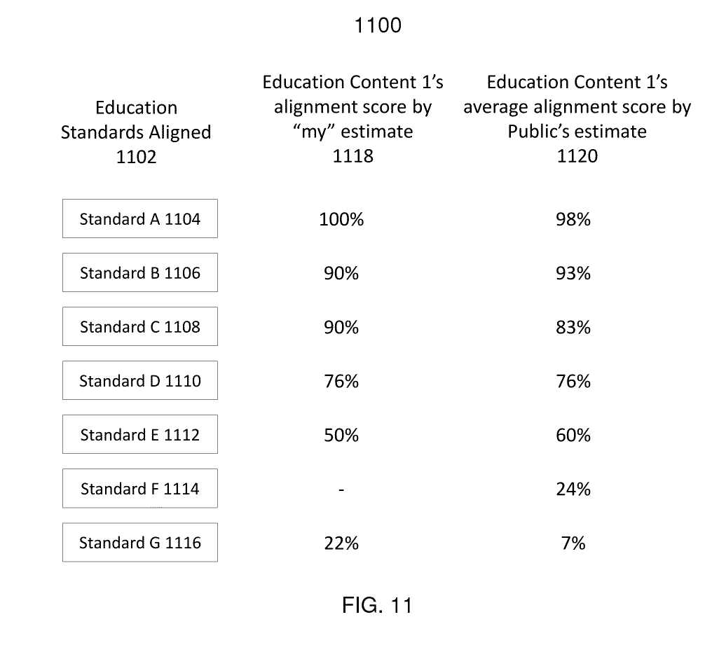

FIG. 11 is a chart of an example of the display of a piece of Education Content's public average alignment score to Education Standards, in accordance with some embodiments. The aligned Education Standards include Education Standard A 1104, Education Standard B 1106, Education Standard C 1108, Education Standard D 1110, Education Standard E 1112, Education Standard F 1114, and Education Standard G 1116. The chart 1100 includes the alignment to each standard estimated by a user or Education Content provider 118 as well as the public 1120. Thus in the examples shown in chart 1100, Education Content 1 1118 is determined by the user or Education Content provider to be 100% aligned with Education Standard A 1104 while the public estimates that Education Content 1 1120 is only 98% aligned with Education Standard A 1104. The average alignment score 1120 can be calculated using the method shown in FIG. 10.

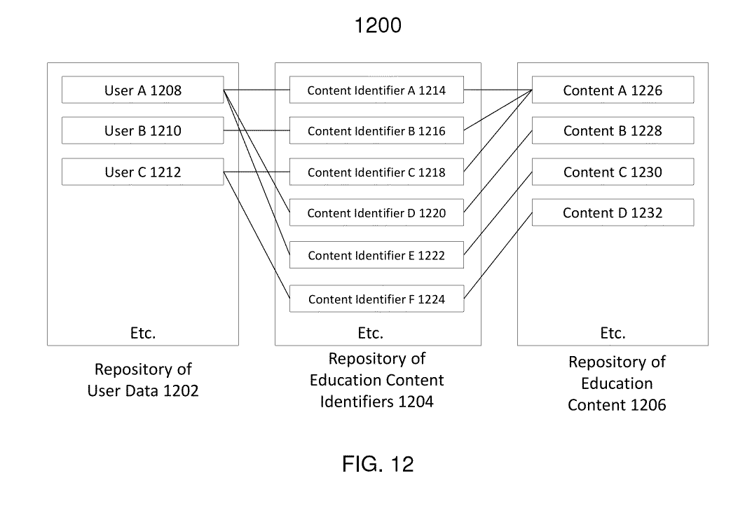

FIG. 12 is a block diagram describing the correlation among user data, Education Content Identifier, and Education Content, in accordance with some embodiments. FIG. 12 shows the connection among Repository of Education Content Identifiers 1204, Repository of Education Content 1206, and Repository of User Data 1202 to associate the content data with user data with Education Content Identifier data. Further, Education Content may be associated with more than one Education Content Identifier. For example, a user A generates an Education Content Identifier F 1224 in accordance to the methods of FIGS. 7A and 7B. Upon generating the Education Content Identifier F 1224, the system saves the Education Content Identifier F 1224 in the Repository of Education Content Identifiers 1204 and correlates the Education Content Identifier F 1224 with Education Content D 1232. Further, the system correlates Education Content F 1224 with user data A 1208 (e.g. user login information).

As will be appreciated by one skilled in the art, aspects of the present disclosure may be embodied as an apparatus that incorporates some software components. Accordingly, some embodiments of the present disclosure, or portions thereof, may combine one or more hardware components such as microprocessors, microcontrollers, or digital sequential logic, etc., such as processor with one or more software components (e.g., program code, firmware, resident software, micro-code, etc.) stored in a tangible computer-readable memory device such as a tangible computer memory device, that in combination form a specifically configured apparatus that performs the functions as described herein. These combinations that form specially-programmed devices may be generally referred to herein “modules”. The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method, comprising:
(a) storing one or more sets of one or more Education Standards in a Repository of Education Standards;
(b) creating one or more Educational Components to generate an Education Standard Identifier to represent each Education Standard;
(c) creating and storing one or more Educational Components in a Repository of Educational Components;
(d) determining a ranking for each Educational Component in representing an Education Standard wherein such ranking in representing an Education Standard has a ranking basis;
(e) assigning a weight to the ranking of each Educational Component in representing an Education Standard;
(f) generating an Education Standard Identifier for each Education Standard based on the one or more Educational Components generated for the Education Standard, the ranking assigned to each of these Educational Components, and the weight assigned to each of the Educational Components at each respective ranking;
(g) storing the Education Standard Identifiers in a Repository of Education Standard Identifiers;
(h) storing one or more pieces of Education Content in a Repository of Education Content;
(i) identifying one or more Educational Components from the Repository of Educational Components to generate an Education Content Identifier to represent each piece of Education Content;
(j) determining a ranking for each Educational Component in representing prioritized educational focuses addressed by a piece of Education Content wherein such ranking in representing the piece of Education Content has a same ranking basis as the ranking basis of an Education Standard Identifier to represent an Education Standard;
(k) generating one or more Education Content Identifiers for each piece of Education Content based on the identified one or more Educational Components, and ranking of each identified one or more Educational Components;
(l) storing the Education Content Identifiers in a Repository of Education Content;
(m) comparing an Education Content Identifier to the Education Standard Identifiers to determine if the Education Content Identifier has one or more Educational Components in common with each of the Education Standard Identifiers wherein when a match is identified, the Education Content correlated to the Education Content Identifier is determined as aligned to the Education Standard Identifier and aligned to the Education Standard correlated to the Education Standard Identifier
(n) calculating the Education Content's degree of such alignment to each of the Education Standards by processing common Educational Components in the Education Content Identifier matched to the Education Standard Identifier for each of the Education Standards, the ranking of each Educational Component in the Education Content Identifier relative to that in each of the matched Education Standard Identifiers, the weights the relative rankings capture based on the assigned weights of the common Educational Components in each Education Standard Identifier, and the Weight Discounting Factors corresponding to the relativity of the rankings to apply to the weights captured.

2. The method of claim 1, further comprises applying a weight discounting factor based on comparing the ranking of the common Educational Component in the Education Content Identifier with the ranking of the Educational Components in the Education Standard Identifier.

3. The method of claim 4, further comprising computing an alignment score based on the weights of the Education Standards Identifier and the weight discounting factors.

4. The method of claim 1, further comprising correlating the Education Content Identifier with User Data.

5. The method of claim 1, further comprising generating the Educational Components stored in the Repository of Educational Components by decomposing one or more Education Standards.

6. The method of claim 1, further comprising determining an average alignment score for Education Content based on a new Education Content Identifier created for the Education Content.

7. A computer server, comprising:
(a) one or more processors;
(b) one or more storage devices coupled to the processors, wherein the one or more storage devices store a Repository of Education Standards, an Repository of Education Content, a Repository of Education Standard Identifiers, and a Repository of Education Content;
(c) one or more modules implemented by the one or more processors, the one or more modules configured to:
(i) store one or more sets of one or more Education Standards in a Repository of Education Standards;
(ii) create one or more Educational Components to generate an Education Standard Identifier to represent each Education Standard;
(iii) create and storing one or more Educational Components in a Repository of Educational Components;
(iv) determine a ranking for each Educational Component in representing an Education Standard wherein such ranking in representing an Education Standard has a ranking basis;
(v) assign a weight to the ranking of each Educational Component in representing an Education Standard;
(vi) generate an Education Standard Identifier for each Education Standard based on the one or more Educational Components generated for the Education Standard, the ranking assigned to each of these Educational Components, and the weight assigned to each of the Educational Components at each respective ranking;
(vii) store the Education Standard Identifiers in a Repository of Education Standard Identifiers;
(viii) store one or more pieces of Education Content in a Repository of Education Content;
(ix) identify one or more Educational Components from the Repository of Educational Components to generate an Education Content Identifier to represent each piece of Education Content;
(x) determine a ranking for each Educational Component in representing prioritized educational focuses addressed by a piece of Education Content wherein such ranking in representing the piece of Education Content has a same ranking basis as the ranking basis of an Education Standard Identifier to represent an Education Standard;
(xi) generate one or more Education Content Identifiers for each piece of Education Content based on the identified one or more Educational Components, and ranking of each identified one or more Educational Components;
(xii) store the Education Content Identifiers in a Repository of Education Content;
(xiii) compare an Education Content Identifier to the Education Standard Identifiers to determine if the Education Content Identifier has one or more Educational Components in common with each of the Education Standard Identifiers wherein when a match is identified, the Education Content correlated to the Education Content Identifier is determined as aligned to the Education Standard Identifier and aligned to the Education Standard correlated to the Education Standard Identifier
(xiv) calculate the Education Content's degree of such alignment to each of the Education Standards by processing common Educational Components in the Education Content Identifier matched to the Education Standard Identifier for each of the Education Standards, the ranking of each Educational Component in the Education Content Identifier relative to that in each of the matched Education Standard Identifiers, the weights the relative rankings capture based on the assigned weights of the common Educational Components in each Education Standard Identifier, and the Weight Discounting Factors corresponding to the relativity of the rankings to apply to the weights captured.

8. The computer server of claim 7, wherein the one or more modules are further configured to apply a weight discounting factor based on comparing the ranking of the common Educational Component in the Education Content Identifier with the ranking of the Educational Components in the Education Standard Identifier.

9. The computer server of claim 7, wherein the one or more modules are further configured to compute an alignment score based on the weights of the Education Standards Identifier and the weight discounting factors.

10. The computer server of claim 7, wherein the one or more modules are further configured to correlate the Education Content Identifier with User Data.

11. The computer server of claim 7, wherein the one or more modules are further configured to generate the Educational Components stored in the Repository of Educational Components by decomposing one or more Education Standards.

12. The computer server of claim 7, wherein the one or more modules are further configured to determine an average alignment score for Education Content based on a new Education Content Identifier created for the Education Content.

13. The computer server of claim 7, wherein the one or more modules are further configured to:
receive Education Standards and Education Standard information through an admin interface;
receive Education Content and Education Content information through a user interface;
wherein the admin interface and the user interface is at least one of web browser, mobile application, and computer application.

14. A system, comprising:
(a) one or more communication networks
(b) an Education Standard provider device coupled to the one or more communication networks, the Education Standard provider device transmitting one or more Education Standards;
(c) a computer server coupled to the one or more communication networks, the computer server configured to:
(i) store one or more sets of one or more Education Standards in a Repository of Education Standards;
(ii) create one or more Educational Components to generate an Education Standard Identifier to represent each Education Standard;
(iii) create and storing one or more Educational Components in a Repository of Educational Components;
(iv) determine a ranking for each Educational Component in representing an Education Standard wherein such ranking in representing an Education Standard has a ranking basis;
(v) assign a weight to the ranking of each Educational Component in representing an Education Standard;
(vi) generate an Education Standard Identifier for each Education Standard based on the one or more Educational Components generated for the Education Standard, the ranking assigned to each of these Educational Components, and the weight assigned to each of the Educational Components at each respective ranking;
(vii) store the Education Standard Identifiers in a Repository of Education Standard Identifiers;
(viii) store one or more pieces of Education Content in a Repository of Education Content;
(ix) identify one or more Educational Components from the Repository of Educational Components to generate an Education Content Identifier to represent each piece of Education Content;
(x) determine a ranking for each Educational Component in representing prioritized educational focuses addressed by a piece of Education Content wherein such ranking in representing the piece of Education Content has a same ranking basis as the ranking basis of an Education Standard Identifier to represent an Education Standard;
(xi) generate one or more Education Content Identifiers for each piece of Education Content based on the identified one or more Educational Components, and ranking of each identified one or more Educational Components;
(xii) store the Education Content Identifiers in a Repository of Education Content;
(xiii) compare an Education Content Identifier to the Education Standard Identifiers to determine if the Education Content Identifier has one or more Educational Components in common with each of the Education Standard Identifiers wherein when a match is identified, the Education Content correlated to the Education Content Identifier is determined as aligned to the Education Standard Identifier and aligned to the Education Standard correlated to the Education Standard Identifier
(xiv) calculate the Education Content's degree of such alignment to each of the Education Standards by processing common Educational Components in the Education Content Identifier matched to the Education Standard Identifier for each of the Education Standards, the ranking of each Educational Component in the Education Content Identifier relative to that in each of the matched Education Standard Identifiers, the weights the relative rankings capture based on the assigned weights of the common Educational Components in each Education Standard Identifier, and the Weight Discounting Factors corresponding to the relativity of the rankings to apply to the weights captured.

15. The system of claim 14, wherein the computer server is further configured to apply a weight discounting factor based on comparing the ranking of the common Educational Component in the Education Content Identifier with the ranking of the Educational Components in the Education Standard Identifier.

16. The system of claim 14, wherein the computer server is further configured to compute an alignment score based on the weights of the Education Standards Identifier and the weight discounting factors.

17. The system of claim 14, wherein the computer server is further configured to correlate the Education Content Identifier with User Data.

18. The system of claim 14, wherein the computer server is further configured to generate the Educational Components stored in the Repository of Educational Components by decomposing one or more Education Standards.

19. The system of claim 14, wherein the computer server is further configured to determine an average alignment score for Education Content based on a new Education Content Identifier created for the Education Content.

20. The system of claim 14, wherein the computer server is further configured to:
receive Education Standards and Education Standard information through an admin interface;
receive Education Content and Education Content information through a user interface;
wherein the admin interface and the user interface is at least one of web browser, mobile application, and computer application.
